(19) United States
(12) Patent Application Publication
(10) Pub. No.: US 2011/0292269 A1
(43) Pub. Date: Dec. 1, 2011

(54) Touch Control Image Capturing And Converting Apparatus

(76) Inventor: Paul Liu, Taipei (TW)

(21) Appl. No.: 12/787,403

(22) Filed: May 26, 2010

(51) Int. Cl. H04N 5/225

(52) U.S. Cl. 348/333.12; 345/173

(57) ABSTRACT

A touch control image capturing and converting apparatus is provided. The touch control image capturing and converting apparatus includes a housing, an insertion slot, a touch control screen, and a start switch. The housing defines a substantially enclosed space. The insertion slot is configured extending through the housing from one side of the housing to an opposite side of the housing, and is adapted for allowing an external picture clip to be inserted therein. The touch control screen is provided on an upper surface of the housing. In operation, the touch control operational options of the touch control screen can be turned on by starting the start switch. Then, the touch control operational options can be operated for adjusting displaying of the digital file obtained by photographing the picture with the image capturing lens

### BACKGROUND OF THE INVENTION

1. Field of the Invention

The present invention relates generally to a touch control image capturing and converting apparatus, and more particularly, to a touch control image capturing and converting apparatus which provides touch control operational options.

2. The Prior Arts

A typical image capturing and converting apparatus is mainly used for photographing a photo, negative, or picture to obtain a digital file for long term conservation. However, when an image is captured, the user may fail to find out the defects of the image at that time. For example, when the user use a digital camera to photograph an image, he may be satisfactory about the photographed image at that time. However, when he input the photographed image to the image capturing and converting apparatus, he may feel unsatisfactory about somewhere of the image, and has to give up the photographed image.

Further, when a conventional image capturing and converting apparatus is used to photograph an image, the operation is often affected by the environment. For example, the variation of the environmental illumination may cause a misjudgment of the quality of the photographed image, such that the viewing angle, reflection of light, or even definition of the photographed image may be adversely affected. Moreover, the captured image cannot be modified anymore.

### SUMMARY OF THE INVENTION

Accordingly, a primary objective of the present invention is to provide a touch control image capturing and converting apparatus which provides touch control operational options.

The present invention provides a touch control image capturing and converting apparatus. The touch control image capturing and converting apparatus includes a housing, an insertion slot, a touch control screen, and a start switch. The housing defines a substantially enclosed space. The insertion slot is configured extending through the housing from one side of the housing to an opposite side of the housing, and is adapted for allowing an external picture clip to be inserted therein. The touch control screen is provided on an upper surface of the housing.

In operation, the start switch is started to turn on the touch control screen. The touch control screen provides a plurality of operational options. A digital file is obtained by photographing a picture secured to the picture clip with an image capturing lens. The obtained digital file can be adjusted by operating the operational options. Further, a way of displaying the digital file can also be adjusted by operating the operational options.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a perspective view illustrating a touch control image capturing and converting apparatus according to an embodiment of the present invention;

FIG. 2 is a back view of the touch control image capturing and converting apparatus;

FIG. 3 is a schematic diagram illustrating an operation of the touch control image capturing and converting apparatus;

FIG. 4 is a schematic diagram illustrating another operation of the touch control image capturing and converting apparatus; and

FIG. 5 is a schematic diagram illustrating another embodiment of the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

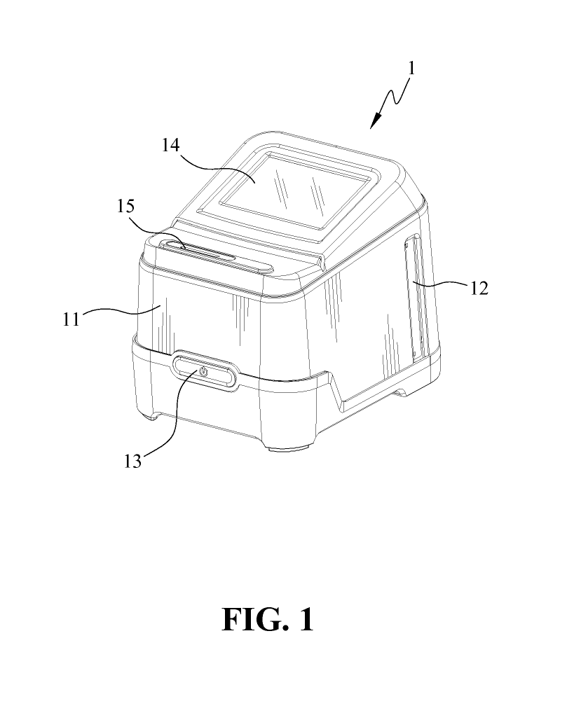

FIG. 1 is a perspective view illustrating a touch control image capturing and converting apparatus according to an embodiment of the present invention. Referring to FIG. 1, the present invention provides a touch control image capturing and converting apparatus 1. The touch control image capturing and converting apparatus 1 includes a housing 11, an insertion slot 12, a start switch 13, and a touch control screen 14. The housing 14 defines a substantially enclosed space. The insertion slot 12 is configured extending through the housing 11 from one side of the housing 11 to an opposite side of the housing 11, and is adapted for allowing an external picture clip 2 to be inserted therein. Preferably, the insertion slot 12 is configured perpendicular with a platform on which the touch control image capturing and converting apparatus 1 is placed. The picture clip 2 is adapted for securing a picture thereby, and carrying the secured picture for being inserted inside the insertion slot 12. The start switch 13 and the touch control screen are provided at an outer surface of the housing 11.

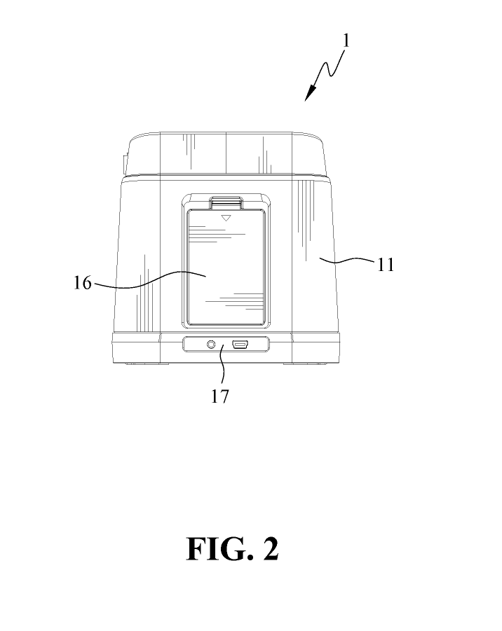

FIG. 2 is a back view of the touch control image capturing and converting apparatus. Referring to FIG. 2, the touch control image capturing and converting apparatus 1 further includes a battery cover 16 and a transmission interface 17. The battery cover 16 and the transmission interface 17 are positioned at a backside of the touch control image capturing and converting apparatus 1. The battery cover 16 covers a battery receiving slot (not shown in the drawings), in which at least one battery (not shown in the drawings) is provided for providing power supply for the touch control image capturing and converting apparatus 1, such that the touch control image capturing and converting apparatus 1 is portable. The transmission interface 17 of the touch control image capturing and converting apparatus 1 for example includes a USB port and an image transmission port for providing a data transmission and image transmission function.

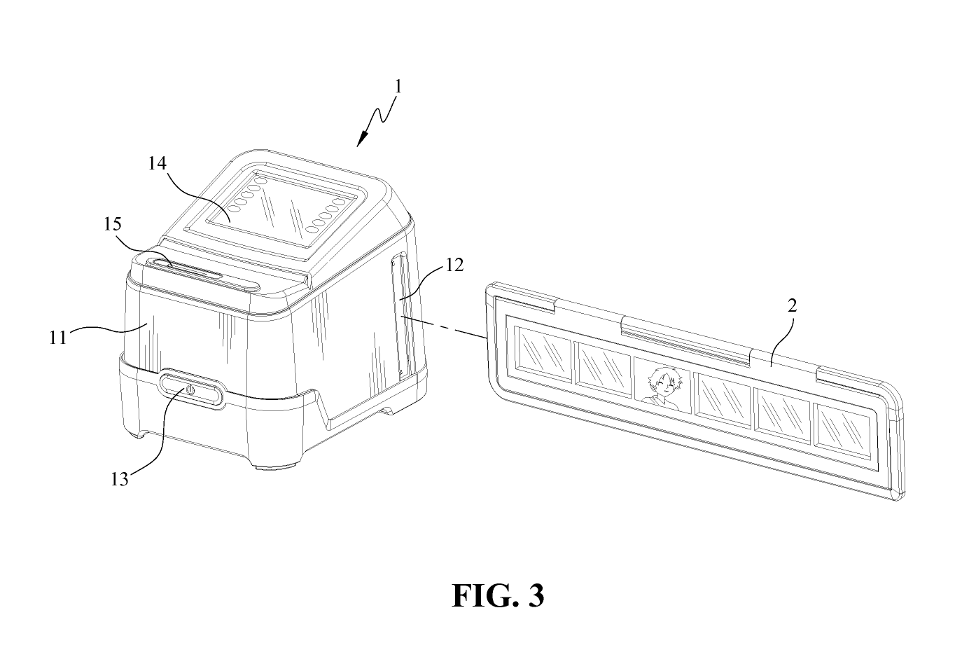

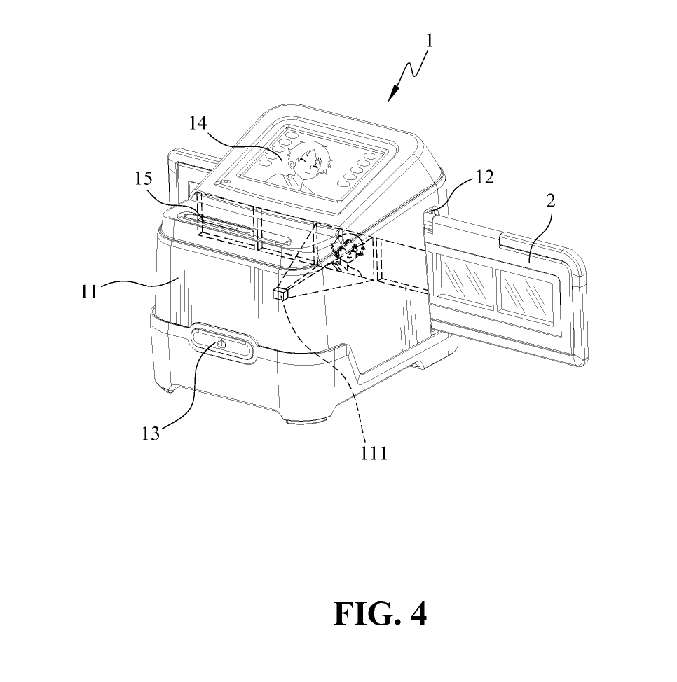

FIG. 3 is a schematic diagram illustrating an operation of the touch control image capturing and converting apparatus. FIG. 4 is a schematic diagram illustrating another operation of the touch control image capturing and converting apparatus. Referring to FIGS. 3 and 4 together, in operation of the touch control image capturing and converting apparatus 1, the start switch 13 is started at first. Then, the picture clip 2 having the picture to be photographed secured thereto is inserted into the insertion slot 12 from one side of the insertion slot 12, and taken out from the opposite side of the insertion slot 12, during which the picture secured to the picture clip 2 is photographed by an image capturing lens 111 disposed inside the housing 11, and is then converted into a digital file. The digital file is then displayed on the touch control screen 14.

Further, the housing 11 may further contain a light source unit (not shown in the drawings). Therefore, the picture to be photographed can be displayed by illuminating with the light source unit. The touch control screen 14 is a touch control sensing unit which provides multiple touch control optional icons. In other words, a user can selectively adjust, select, modify, or arrange the captured digital file by touching the optional icons. For example, the user is allowed to manually adjust the size, angle, brightness, permutation and combination of the captured image(s), or introduce additional pattern into the image or remove a certain part from the image by touching the optional icons.

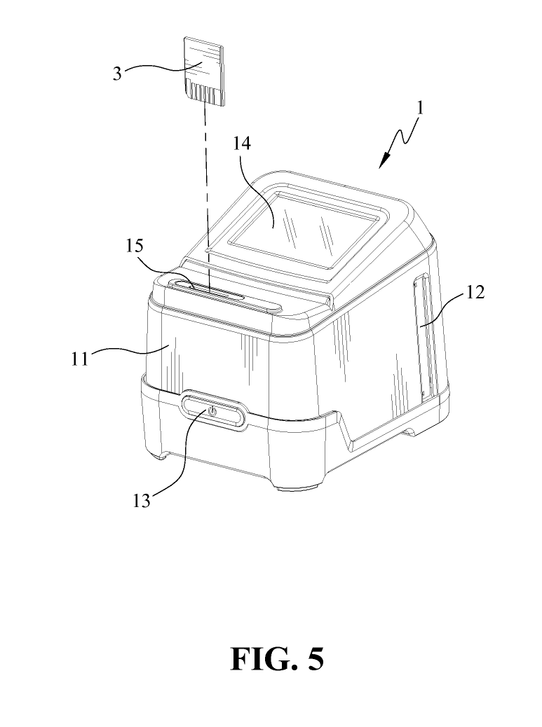

FIG. 5 is a schematic diagram illustrating another embodiment of the present invention. As shown in FIG. 5, the touch control image capturing and converting apparatus 1 further includes memory card port 15. The memory card port 15 is adapted for connecting a security memory digital card 3 (SD card) therewith. By connecting the SD card 3 to the memory card port 15, a digital file saved in the SD card 3 can be transmitted to the touch control screen 14, so as allow to directly adjust the digital file on the touch control screen 14. For example, those digital files obtained by a digital camera, a cell phone, or other multimedia apparatuses can be transmitted to the touch control screen 14. Further, the memory card port can also be alternatively a USB port.

Furthermore, according to a further embodiment of the present invention, the touch control image capturing and converting apparatus 1 further includes a stylus (not shown in the drawings). The user can use the stylus instead of his fingers to touch the touch control screen 14. In such a way, the contamination to the touch control screen 14 by fingers can be avoided.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A touch control image capturing and converting apparatus, comprising:
a housing, having an image capturing lens disposed therein;
an insertion slot configured through the housing from one side of the housing to an opposite side of the housing;
a picture clip, having at least one picture secured thereto, wherein the picture clip is adapted for being inserted through the insertion slot so as to carry the picture secured thereto into the housing;
a touch control screen, providing the touch control operational options for adjusting displaying of the digital file obtained by photographing the picture with the image capturing lens; and
a start switch, provided at an outer surface of the housing, wherein the touch control screen can be turned on by starting the start switch.

2. The touch control image capturing and converting apparatus as claimed in claim 1, further comprising a touch control type stylus.

3. The touch control image capturing and converting apparatus as claimed in claim 1, wherein the housing comprises a USB port.

4. The touch control image capturing and converting apparatus as claimed in claim 1, wherein the housing comprises a security memory card (SD card) port.

5. The touch control image capturing and converting apparatus as claimed in claim 1, wherein the touch control screen is provided at an upper surface of the housing.

6. The touch control image capturing and converting apparatus as claimed in claim 1, wherein the start switch is positioned at a front side of the housing.

7. The touch control image capturing and converting apparatus as claimed in claim 1, further comprising a transmission interface.

8. The touch control image capturing and converting apparatus as claimed in claim 1 further comprising a battery cover.
